(19) United States
(12) Patent Application Publication
(10) Pub. No.: US 2014/0103549 A1
(43) Pub. Date: Apr. 17, 2014

(54) SINGLE SERVE CARBONATION APPARATUS

(71) Applicant: BENJAMIN DAVID STANELAND, Davenport, FL (US)

(72) Inventor: BENJAMIN DAVID STANELAND, Davenport, FL (US)

(21) Appl. No.: 13/653,173

(22) Filed: Oct. 16, 2012

(51) Int. Cl. B01F 3/04

(52) U.S. Cl. CPC B67D 1/0069
USPC 261/62; 261/DIG. 7

(57) ABSTRACT

The present invention is related to a single serve carbonation apparatus comprising a carcass that supports components including a removable pressurized gas canister, a canister receiver that regulates the flow of gas, an operative spigot to receive the bottled beverage and provide the gas inlet, a tap handle mechanism, and internal tubing to provide the channeling of gas and pressurized liquid throughout the process. With gas canister inserted and the selected beverage attached to the operative spigot, the circuit is then switched on allowing the gas into the bottle creating a pressurized flow of draught-like beverage, dispensed via the tap handle, into the glass. The present apparatus allows users to enjoy any bottled beverage at any time. The installation and removal of said canister is easy, keeping the unit small, portable and affordable. There is no need to power the unit since the bottles are already chilled.

This Non-Provisional Patent Application is submitted subsequent to Provisional Patent Application 61/547,946 and should be received with knowledge of the PPA receipt date of Oct. 17, 2011 and afforded all the advantages granted as such.

### BACKGROUND OF THE INVENTION

1. Field Of The Invention

The present invention relates generally to an apparatus to provide an individually-bottled beverage with the increased quality and taste of a draught beverage. The invention is, however, more particularly directed to a single serve carbonation apparatus that allows a user to enjoy any individually-packaged beverage at any time, using a receiver for accepting a small compressed gas (typically Carbon Dioxide or Nitrogen) canister that provides for easy installation/removal of the chosen compressed gas, portability and low cost.

2. Description Of The Prior Art

There are basically two types of beers in the market, namely: the draught beer and the bottled/canned beer. Draught beers are the alcoholic beer beverages that come from or are poured down from a tap into a glass. Bottle/Canned beers are those beers that are contained inside bottles/cans or are drunk from the bottles/cans. This difference in the manner they are consumed gives way to many significant changes in the taste, texture and even the lifespan of the beer itself.

The way beer is stored and transported has a major bearing on how beer tastes when it is served. The main reason that draught beer is popular is that it retains most of the flavor that it had when it was brewed. Also, its flavor is less affected by the packaging process than canned or bottled beer.

The overall taste and odor (aroma) of the two types of beers also differ. Bottled/Canned beers store their entire aroma inside their bottles/cans whereas draught beers are more flavorful because the beverage is poured into the glass making its aroma stand out for a while. Bottle/Canned beers can imitate draught beers only after they are poured into a separate drinking glass before consumed.

Another consideration may be made on what the experts call ‘mouthfeel’. When pouring beer from a tap, the rate of pour and the amount of compressed gas can seriously affect the taste sensation. Because of the way they are stored and served, draught beers give much better ‘mouthfeel’ when poured by a competent bartender.

In order to overcome the above mentioned inconveniences, some companies produce beer that they call ‘bottled draughtbeer’. Unlike other bottled beers, they have not undergone pasteurization. However, to make sure the beer does not spoil, bottled draught beer is subjected to cold, sterile filtration, removing much of its flavor.

Another factor that affects the bottled beer is the sunlight or fluorescent light that causes oxidation inside bottles affecting its final quality, and the exposure to high temperatures that can also spoil the product. The taste of both canned and bottled beers is normally improved by pouring them into a glass before drinking, even though the result is not even close to a draught beer.

There have been some attempts in the prior art to solve the above mentioned inconveniences. For example, a method and apparatus exists for injecting gas into a bottled fluid to carbonate or maintain carbonation in the liquid, wherein a valve coupling having a conduit extending there through, which is adapted to fixedly attach to the nozzle of a bottle containing liquid.

Another example is a system and apparatus for the production of sparkling wine by applying carbon dioxide to wine that is already bottled, utilizing a high pressure cap-type enclosure permitting the carbon dioxide to be applied through the cap with an applicator in the nature of a hypodermic needle.

Also known is an attachment adapted for a carbonated liquid container which pressurizes the beverage within the container with carbon dioxide or other pressurized gaseous fluid. The attachment is adapted to screwably attach to the nozzle of a bottle container, and provides the user with the ability to vary and control the gas pressure of the container by manipulating a button extending from the attachment.

Such systems and apparatus are often complex, awkward and cumbersome, and furthermore do not enable the user to adequately produce a draught-like beverage from an originally bottled product, such as from glass bottles containing wine or beer, for example.

Therefore, even though the above cited solutions of the prior art address some of the needs of the market, a new, improved and economical single serve carbonation apparatus is still desired.

### SUMMARY OF THE INVENTION

This invention is directed to a single serve carbonation apparatus with which it is possible to serve a draught-like beverage, for example, beer, from a bottled beverage by forcing the liquid out of the bottle through injecting pressurized gas into the bottle and pouring it into a glass.

In one general aspect of the present invention, a single serve carbonation apparatus is introduced including a means for inserting a compressed gas canister, a means for inserting a bottled beverage and a means for channeling the pressurized gas and liquid from the bottle into a glass.

Accordingly, it is a primary objective of the present invention to provide a single serve carbonation apparatus with which it is possible to enhance the mouth taste of a bottled beer.

Another aspect of the present invention provides a single serve carbonation apparatus that may be used to serve a draught-like beverage including, but not limited to, beer, soda, wine, etc.

Yet another aspect of the purposed invention comprises a single serve carbonation apparatus that is portable and the customer may use at home for enhancing the aspect and flavor of different beverages.

Yet another aspect of the purposed invention comprises a single serve carbonation apparatus that allows the user to enjoy any bottled beverage at any time utilizing a receiver for accepting a small compressed gas canister. The installation and removal of said canister is easy, keeping the unit small, portable and affordable. Since the customer uses an already chilled beverage bottle, there is no need to power the unit.

Also another aspect of this invention comprises a single serve carbonation apparatus that introduces compressed gas directly into the bottle to force the beverage out of the container.

Another known solution is a residential draught beer dispensing device or ‘kegerator’. A keg, typically of beer, is stored in a refrigerated container to keep the keg chilled. It is possible to maintain a tapped keg in such a device for extended periods of time, usually a couple of months, without losing any quality in the taste of the beer. These devices have several disadvantages, including: only one single beer flavor may be used until the keg is empty; large not portable size; requires electricity to provide an acceptable temperature; high cost; etc.

In summary, the present invention is related to a single serve carbonation apparatus comprising a carcass that supports the components including an internal removable compressed gas canister that provides the pressurized gas, a canister receiver that sends the pressurized gas to a pressure regulator, an operative spigot to receive the bottled beverage and provide the gas inlet, a tap and handle mechanism attached to a lateral wall of the carcass to switch on and off the flow of beer into the glass, and internal tubing to provide the channeling of gas and beer throughout the process.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a general perspective view of the single serve carbonation apparatus in accordance with the present invention.

FIG. 2 is another perspective view of the present invention, this time showing the back portion thereof.

FIG. 3 schematically shows how the present apparatus works.

### DETAILED DESCRIPTION OF REPRESENTATIVE EMBODIMENTS

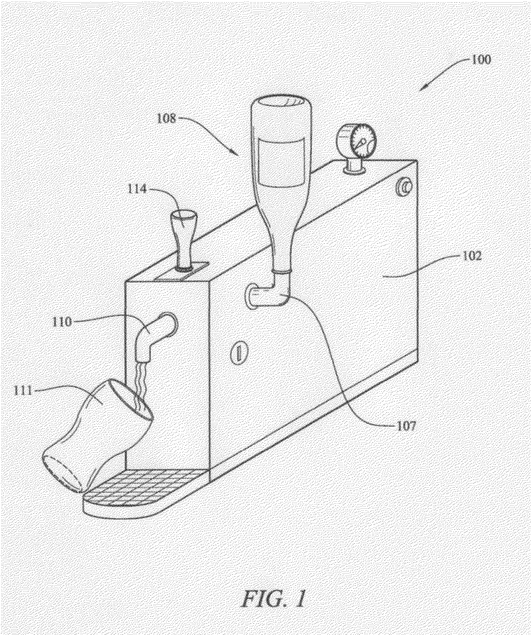

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices illustrated in the attached drawings, and described in the following specification, are simply exemplary embodiments of the inventive concepts defined in the appended claim. Hence, specific dimensions and other physical characteristics relating to the embodiments disclosed herein are not to be considered as limiting, unless the claims expressly state otherwise.

Shown throughout the Figures, the invention is directed to a single serve carbonation apparatus 100 comprising an exemplary parallelepiped carcass 102 that may be made of metal, plastic, wood or the like. When this apparatus is used at home, the external appearance will be important, therefore this carcass may be made of attractive materials including, but not limited to, wood, stainless steel, copper, aluminum, etc.

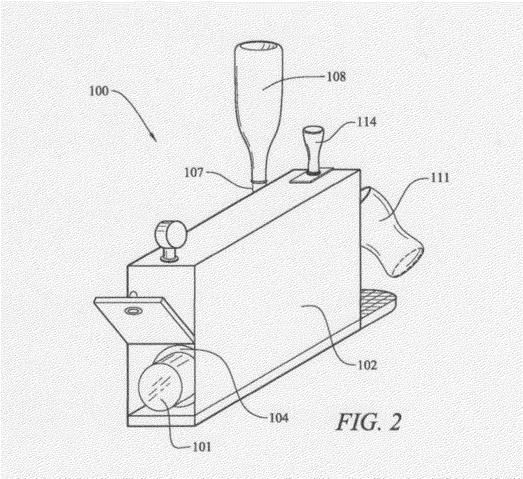

FIGS. 1 and 2 are respective front and rear perspective views of an exemplary embodiment of the present apparatus 100 showing an operative spigot 107 to receive a bottled beverage 108 and provide the compressed gas inlet, a canister receiver 104 into which an exemplary canister 101 of pressurized gas is inserted, and a spout 110 to deliver the extra carbonated liquid into a receptacle 111, a tap 114 to switch on and off the valve 105 which allows the flow of beer and pressurized gas from the bottle 108 through an internal tubing 117 to channel the draught beer through the tap 110 into a receptacle 111.

Even though this should not be interpreted as a limitation of the present invention, the carbonated liquid may be beer and the container 111 may be a beer glass, a beer mug or the like.

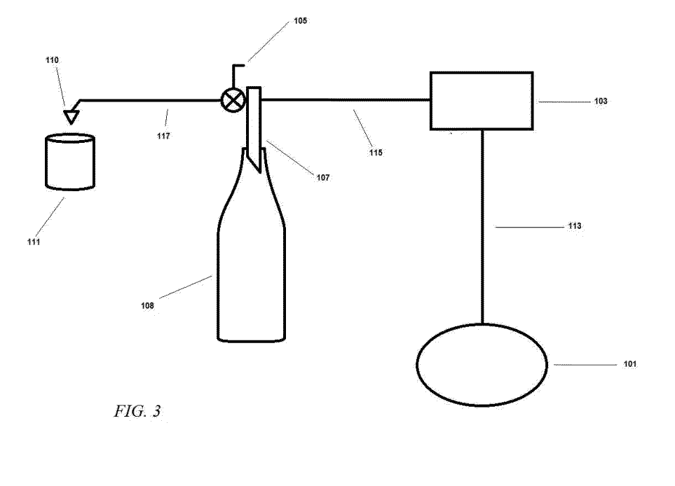

Making reference to FIG. 3 the operation of a single-serve carbonation operation is now explained. The container of high pressure gas or canister 101 delivers high pressure gas that travels along tubing 113 into the adjustable pressure regulator mechanism 103. Said pressure regulator 103 contains an adjustable output that reduces the incoming gas pressure to a desired lower output pressure. The lower pressure gas travels along tubing 115 through the spigot 107 into the bottle 108. The valve 105, when opened (by operating on the tap 114), allows the beer pressurized with the compressed gas to flow through the tubing 117 through the spout 110 and into the glass 111 ready for consumption. When closed (by operating on the tap 114), the draught beer is not allowed to pass through the valve 105.

The two-way spigot 107 has an outer diameter of such a size and construction that it fits snugly within the interior diameter of the mouth of the container 108 of carbonated liquid, thus providing an air-tight seal. The pressurized gas travels through the spigot 107 to enter the container 108 of carbonated liquid.

Into said exemplary container 108 of carbonated liquid the two-way spigot 107 is inserted. The now extra carbonated liquid now flows back through the spigot 107 in the direction of the valve 105. The design of this two-way spigot prevents the extra carbonated liquid from flowing back through tubing 115 because of the pressure within tubing 115 so the extra carbonated liquid is directed in the direction of the valve mechanism 105. Once opened (by operating on the tap 114), the extra carbonated liquid travels through the valve 105 along the tubing 117 toward the spout mechanism 110. This spout 110 is designed in such a manner that it provides a smooth delivery of extra carbonated liquid into the chosen receptacle 111.

Even though in the above description and in the attached drawings a bottle container 108 is described and illustrated, it is obvious for those skilled in the art that a typical aluminum beer or soda can may also be used as a container. In that case, the outer diameter and shape of the spigot 107 must have a size and construction that fits snugly through the casing and within the interior shape of the can of carbonated liquid, providing the required air-tight seal. Due to the different shapes and sizes the can may have, the connection between said can and the spigot may also be made using different means, with or without physical contact between the parts.

While the preferred embodiments of the invention have been described above, it will be recognized and understood that various modifications can be made in the invention and the appended claims are intended to cover all such modifications which may fall within the spirit and scope of the invention.

I claim:

1. Single serve carbonation apparatus comprising a parallelepiped carcass that supports the components including an internal removable pressurized gas canister, a canister receiver, an operative spigot, a tap handle mechanism attached to a valve through a lateral wall of the carcass and internal tubing to create fluid communication between the components.
